(19) United States
(12) Patent Application Publication
(10) Pub. No.: US 2026/0213669 A1
(43) Pub. Date: Jul. 23, 2026

(54) MULTI-PHASE CONVERTER

(71) Applicant: Delta Electronics (Thailand) Public Co., Ltd., Samutprakarn (TH)

(72) Inventor: Jitendra SOLANKI, Soest (DE)

(21) Appl. No.: 19/446,898

(22) Filed: Jan. 12, 2026

(30) Foreign Application Priority Data
Jan. 22, 2025 (EP) 25153384.0

(51) Int. Cl. H02M 3/335; H02M 3/00

(52) U.S. Cl. CPC H02M 3/33576; H02M 3/01; H02M 3/33571

(57) ABSTRACT

The application concerns a multi-phase converter, comprising: a transformer device with a primary side with primary winding and a secondary side with secondary winding; a primary side circuit connected to the primary winding; and a secondary side circuit connected to the secondary winding; wherein the secondary side circuit comprises a plurality of rectification legs with rectification elements and an output capacitor leg with a plurality of output capacitors, the secondary winding is connected in star configuration, and a star-point of the secondary winding is connected to a middle-point of the plurality of output capacitors.

### CROSS-REFERENCE TO RELATED APPLICATIONS

This application claims priority to European Patent Application No. 25153384.0, filed on January 22, 2025, and entitled "MULTI-PHASE CONVERTER", the content of which is hereby incorporated by reference in its entirety.

### TECHNICAL FIELD

The application concerns a multi-phase converter.

### BACKGROUND

Commonly, three-phase LLC unidirectional converters are used especially in the automotive field. Three-phase converters produce common mode voltage. However, in known topologies, a transformer thereof comprises parasitic capacitances. For example, there exists parasitic capacitance, also referred to as stray capacitance, between transformer windings, i.e., between primary side windings and secondary side windings, as well as the respective windings and a housing, i.e., between the primary windings and the housing, and between the secondary windings and the housing. Especially in topologies in which a secondary side of the transformer is connected via a star configuration, these stray capacitances lead to production of resonance with inductances present in resonant circuit. At the star-point of the secondary side of the transformer, the voltage oscillates and commonly demonstrates an oscillating frequency of roughly three times or multiple of three-times of the operating frequency.

Due to this common-mode voltage, especially with an oscillating frequency three times the frequency of operation, a resonance between resonance-inductance and the transformer parasitic inductance takes place. This resonance increases losses in the transformer and leads to higher temperatures, as well as lower efficiency of the converter. These problems are especially severe in automotive applications, where magnetic components of these topologies are commonly potted for cooling, thus increasing the parasitic capacitances, especially between the windings and the housing.

### SUMMARY

It is an object of the present application to overcome these deficiencies. In particular, it is an object of the present application to provide a multi-phase converter in which resonances due to common-mode voltages are suppressed, and which further comprises reduced or no resonance between resonance-inductance and transformer parasitic inductance, and which has lower losses, lower temperature, and higher efficiency.

In particular, the solution of these objects is achieved by the multi-phase converter according to the present application. The multi-phase converter comprises a transformer device with a primary side with primary winding and a secondary side with secondary winding. Furthermore, the converter comprises a primary side circuit connected to the primary winding and comprising a plurality of primary switch legs in parallel, and a secondary side circuit connected to the secondary winding. Therein, the secondary side circuit comprises a plurality of rectification legs with rectification elements and an output capacitor leg with a plurality of output capacitors. The secondary winding is connected in star configuration. Furthermore, a star-point of the secondary winding is connected to a middle-point of the plurality of output capacitors.

By providing the star-point of the secondary winding as being connected to the middle-point of the plurality of output capacitors, a pathway for common-mode currents is provided, which therefore stabilizes a star-point voltage, i.e., a voltage at the star-point of the secondary winding. Thereby, since the common-mode currents are diverted, an oscillation of the star-point voltage due to common-mode voltages is suppressed, and therefore a resonance with the parasitic inductances caused by the parasitic capacitances is also suppressed. Therefore, the multi-phase converter has lower losses, reduced temperature, as well as higher efficiency.

In the sense herein, “primary” and “secondary” refer to a case in which for example power is transferred from the converter to a load, for example a battery. In some cases herein, a bidirectional converter is discussed. In such cases, the terms “primary” and “secondary” are interchangeable. However, even in these cases for easier understanding, the terms “primary” and “secondary” will be nonetheless used when referring for example to a reverse power flow direction while referring to the same sides as with forward power flow direction (i.e., the definitions will not be interchanged depending on power flow direction, for easier understanding). Reverse power flow direction will thus be defined as “from secondary side to primary side”.

In an implementation, the multi-phase converter comprises three or more, especially six or more phases. For example, three phases or six phases. In an implementation, the multi-phase converter is a DC-DC converter. In some embodiments, the present multi-phase converter is implemented as a DC-DC stage of an AC-DC converter.

In an implementation, and as will be elucidated below, rectification elements of the secondary side circuit are diodes and/or switches.

In an implementation, in the three-phase converter example, the primary side circuit comprises three primary switch legs, each comprising two switches in series with one another, wherein the primary switch legs are connected in parallel to one another and in parallel to an input voltage.

In an implementation, the transformer device comprises one transformer, connected to all phases of the primary and/or secondary side. In other implementations, the transformer device comprises a plurality of transformers, especially corresponding to the number of phases, for example, three or six transformers. Therein, in an implementation, each transformer is connected to one phase of the primary and/or secondary side circuit.

In an implementation, the output capacitor leg of the secondary side circuit is directly connected, in parallel, between the rectification legs and an output of the secondary side circuit. In an implementation, the output capacitor leg is only connected, in parallel, to the rectification legs and the output of the secondary side circuit, and to the star-point of the secondary winding. In other words, in an implementation, the output capacitor leg is only connected to the rectification legs and to the star-point of the secondary winding, wherein the secondary side circuit is further connected to the output of the multi-phase converter. In yet other words, in an implementation, the star-point of the secondary winding is directly connected to the middle of the plurality of output capacitors, and, via the secondary winding, to the rectification legs of the secondary side circuit, without being connected to any other further elements (apart from secondary side resonance elements, for example).

In an implementation, the star-point of the secondary winding is connected to the middle-point of the output capacitors directly or using an impedance and/or a switch.

In particular, the star-point of the secondary winding or the middle-point of the plurality of output capacitors of the secondary side circuit are not further directly connected to elements of the primary side circuit. In other words, the star-point of the secondary winding and the middle-point of the plurality of output capacitors are only connected to the primary side circuit indirectly via the transformer device, which insulates the primary side circuit from the secondary side circuit. Furthermore, in an implementation, the primary side circuit and the secondary side circuit are only connected to one another via the transformer device, without any direct electrical connection there between, thereby maintaining galvanic isolation between primary and secondary side of the circuit.

In an implementation, the output capacitor leg comprises a plurality of output capacitors connected in series with one another. These output capacitors can be realized by connecting several capacitors in series and parallel. Therein, the middle-point is substantially in the middle of all output capacitors, where the middle of all output capacitors refers to the electrical middle of all output capacitors. Where the output capacitor leg comprises an even number of output capacitors connected in series with one another. This means a plurality of equal capacitor sets are connected in series and middle connection point is connected to the star point. Capacitor values can be subjected to manufacturing tolerances. Middle point is defined such as the total electrical impedance from mid-point to positive rail is equal to impedance from mid-point to negative rail. Whereas impedance is subjected to manufacturing tolerances. In this regard, in an implementation, the electrical middle refers to electrical lengths. In an implementation, the term "substantially in the middle" refers to manufacturing errors, which can cause a deviation from the exact middle by ± 5%. In an implementation, the term "middle" is with reference to a total length, especially electrical length, of the output capacitor leg. Alternatively, in an implementation the "middle" may refer to half of the length, especially the electrical length, between one-half of the output capacitors and the other half of the output capacitors. For example, in a case of two output capacitors, the "middle" refers to the physical or electrical middle of a wire length between the two output capacitors.

In an implementation, the primary winding is connected in delta configuration and the primary side circuit comprises a plurality of resonant capacitors connected to the primary winding in delta configuration.

In an implementation, the multi-phase converter is bidirectional, and the secondary side circuit further comprises a resonant tank connected in star configuration along with the secondary winding.

In an implementation, the primary winding is connected in star configuration, and the primary side circuit comprises a plurality of resonant capacitors connected to the plurality of primary switch legs at one end and to the primary winding in star configuration.

In an implementation, the multi-phase converter is bidirectional, and the secondary side circuit further comprises a resonant tank connected in star configuration along with the secondary winding.

In an implementation, the multi-phase converter further comprises an input capacitor leg with a plurality of input capacitors connected in series, a star-point of the primary winding is connected to a middle-point of input capacitors of the input capacitor leg of the primary side circuit. In an implementation, in accordance with the foregoing explanations regarding output capacitors and an output capacitor leg of the secondary side circuit, the same applies to the input capacitor leg of the primary side circuit as well as the middle-point of input capacitors thereof. For example, the input capacitor leg of the primary side circuit is connected in parallel to primary switch legs of the primary side circuit. Furthermore, for example, the input capacitor leg of the primary side circuit comprises a plurality of input capacitors, especially an even number of input capacitors, especially two or four input capacitors. In an implementation, the "middle-point" thereof also refers to the physical or electrical middle of the input capacitor leg, especially the wire distance between halves of multiple input capacitors.

In an implementation, the star-point of the primary winding is connected to the middle-point directly or using an impedance and/or via a switch. Therein, in an implementation, as with the foregoing explanation regarding the middle-point of output capacitors, the star-point of the primary winding is connected only to the input capacitor leg and the primary switch legs via the primary winding. In the exemplary case of including a switch between the primary side star-point and the middle-point of the output capacitors, in exemplary implementation in a bidirectional converter (see below), the star-point to middle-point connection can be selectively activated, when power transfer is reversed, i.e., from “secondary” to “primary” side. Thereby, during “normal” operation, i.e., “primary” to “secondary” power transfer, efficiency can be increased by deactivation of the switch.

The inclusion of impedance between star-point and middle-point of the capacitors helps to reduce the current flowing between these two points. This in turn reduces the losses in the system. Further a switch can be used to enable and disable the connection between star-point and middle-point of the capacitors, especially depending on the operating frequency, as resonance can be more pronounced at some operating frequencies and less at other operating frequencies. Thereby, the losses occurring in the system due to the flow of current between star-point and middle-point of the output capacitors can be reduced or eliminated.

In an implementation, the primary side circuit comprises a resonant tank connected to the primary winding in delta configuration.

In an implementation, the primary side circuit comprises a resonant tank connected along with the primary winding in star configuration.

In further implementations, the primary side circuit comprises delta connected resonant capacitors. In an implementation, the primary winding thereof is connected in delta configuration. Alternatively, in an implementation, the delta connected resonant capacitors can be combined with the primary winding in star connection, and vice versa, i.e., star connected resonant capacitors can be connected to delta connected primary winding.

In an implementation, in some embodiments, the primary side circuit comprises star connected resonant capacitors. As also elucidated above, in an implementation, the star connected resonant capacitors of the primary side circuit are combinable with the primary winding being connected in star configuration or with the primary winding being connected in delta configuration.

In an implementation, the converter is unidirectional, wherein at least a part of the rectification elements of the secondary side circuit are diodes. In an implementation, the rectification elements of the secondary side circuit are all diodes or are diodes and switches. For example, the rectification legs of the secondary side circuit comprise respectively one switch and one diode connected in series with one another. Alternatively, the rectification legs of the secondary side circuit comprise two diodes connected in series with one another.

Alternatively, in an implementation, the converter is bidirectional, wherein the rectification elements of the secondary side circuit are switches. Therein, in an implementation, all rectification elements of the secondary side circuit are switches. For example, each rectification leg of the secondary side circuit comprises two switches in series with one another.

In an implementation, the converter is an LLC converter or a series resonant converter. In an implementation, both LLC and SR (series resonant) converter examples are combinable with unidirectional or bidirectional examples as above. In an implementation, the series resonant converter in the unidirectional case comprises switches and diodes as rectification elements, as elucidated above.

In an implementation, the primary side circuit comprises a plurality of the primary switch legs with primary switches, wherein each of the primary switch legs comprises a plurality of stacked primary half-bridges connected in series with one another. Therein, the primary switch legs are connected in parallel to one another; and one phase of the primary side of the transformer device is connected between two stacked primary half-bridges in series with one another. In other words, the primary side of the transformer device thereof is connected between two different stacked primary half-bridges in series with one another.

In an implementation, the primary side circuit further comprises an input capacitor leg with a plurality of input capacitors, the plurality of input capacitors are connected in parallel with the stacked primary half-bridges respectively.

In an implementation, each of the rectification legs of the secondary side circuit comprises a plurality of stacked secondary half-bridges connected in series with one another, the rectification legs are connected in parallel to one another; where one phase of the secondary side of the transformer device is connected between two stacked secondary half-bridges in series with one another.

In an implementation, for each of the rectification legs, a flying capacitor is connected between the stacked secondary half-bridges connected in series.

In an implementation, the multi-phase converter is a multi-phase multi-level converter.

In an implementation, the multi-phase converter is an LLC converter and the rectification elements of the rectification legs are diode.

In an implementation, the multi-phase converter is a series resonant converter and the rectification elements of the rectification legs comprise diodes and switches.

In an implementation, the multi-phase converter is bidirectional, and the primary side circuit comprises an input capacitor leg, the plurality of primary switch legs and the input capacitor leg of the primary side circuit and the rectification legs and the output capacitor leg of the secondary side circuit are connected in star configuration.

The foregoing described embodiments and configurations may be combined.

Further details, advantages, and features of the embodiments of the present application are described in detail with reference to the figures.

### BRIEF DESCRIPTION OF DRAWINGS

FIG. 1 shows a schematic diagram of a multi-phase converter according to a first embodiment of the present application.

FIG. 2 shows a schematic diagram of a multi-phase converter according to a second embodiment of the present application;

FIG. 3 shows a schematic diagram of a multi-phase converter according to a third embodiment of the present application.

FIG. 4 shows a schematic diagram of a multi-phase converter according to a fourth embodiment of the present application.

FIG. 5 shows a schematic diagram of a multi-phase converter according to a fifth embodiment of the present application.

FIG. 6 shows a schematic diagram of a multi-phase converter according to a sixth embodiment of the present application.

FIG. 7 shows a schematic diagram of a multi-phase converter according to a seventh embodiment of the present application.

FIG. 8 shows a schematic diagram of a multi-phase converter according to an eighth embodiment of the present application.

FIG. 9 shows a schematic diagram of a multi-phase converter according to a ninth embodiment of the present application.

FIG. 10 shows a schematic diagram of a multi-phase converter according to a tenth embodiment of the present application.

FIG. 11 shows a schematic diagram of a multi-phase converter according to an eleventh embodiment of the present application.

FIG. 12 shows a schematic diagram of a multi-phase converter according to a twelfth embodiment of the present application.

FIG. 13 shows a schematic diagram of a multi-phase converter according to a thirteenth embodiment of the present application.

### DESCRIPTION OF EMBODIMENTS

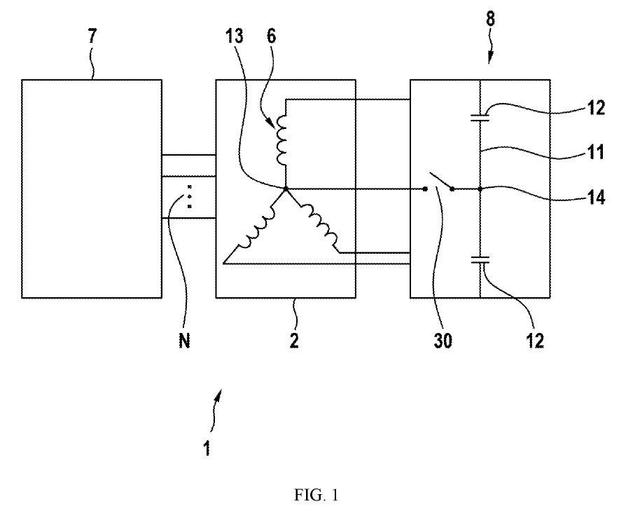

A first embodiment of the present application will be described with reference to FIG. 1. FIG. 1 shows a schematic diagram of a multi-phase converter 1 according to a first embodiment of the present application.

In the sense herein and in the following, “primary” will refer to left sides of the figures, while “secondary” will refer to the right sides of the figures. In following examples of bidirectional converters 1, the same nomenclature with reference thereto will be followed as in unidirectional converters 1, for easier understanding. It goes without saying that reverse power transfer in bidirectional converters 1 thus will correspondingly be denoted as being carried out from the “secondary side” to the “primary side”.

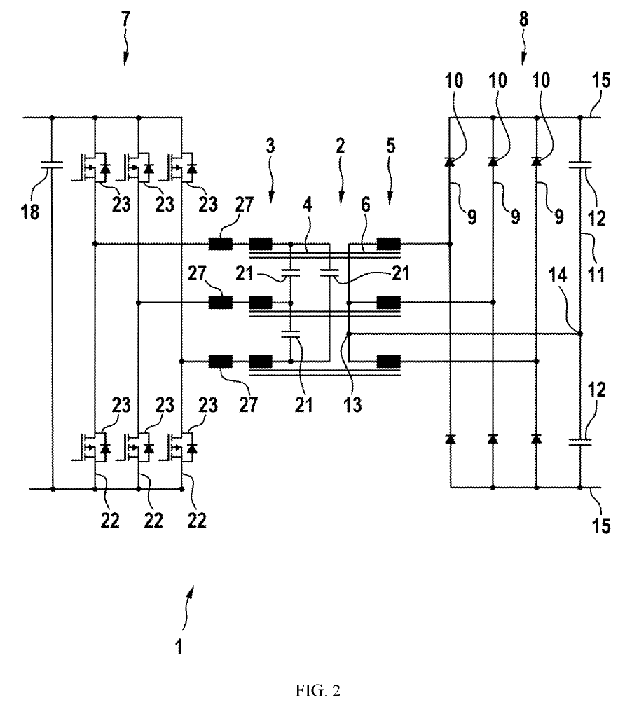

As can be taken from FIG. 1, the multi-phase converter 1, henceforth referred to as “converter”, comprises a transformer device 2. The transformer device 2 comprises a primary side 3 with primary winding 4, which will be explained in detail below with reference to FIGS. 2-11. Furthermore, the transformer device 2 comprises a secondary side 5 with secondary winding 6. For ease of understanding, FIG. 1 shows only the secondary winding 6 of the transformer device 2.

In general, the converter 1 and the transformer device 2 are multi-phase, comprising N phases. In the present embodiments, primarily three-phase, i.e., N = 3, configurations will be explained. In alternative embodiments, the converter 1 may comprise more than three, particularly six, phases.

The converter 1 further comprises a primary side circuit 7 and a secondary side circuit 8. The primary side circuit 7 receives an input voltage to be converted and the secondary side circuit 8 rectifies the voltage received from the transformer device 2 (or vice versa in a bidirectional reverse operation). The primary side circuit 7 will be explained in more detail further below.

The secondary side circuit 8 comprises an output capacitor leg 11 with a plurality of output capacitors 12 for smoothing and stabilizing the output voltage. In the present example, two output capacitors 12 are shown. However, the converter 1 may also comprise more than two output capacitors 12, wherein, in an implementation, the converter 1 comprises an even number, for example four or six or eight output capacitors 12.

As can be taken from FIG. 1, the secondary winding 6 is connected in star configuration and connected to the secondary side circuit 8. Herein, an exemplary case of three phases is shown for easier understanding. The star connection of the secondary winding 6 forms a star-point 13.

Herein, the star-point 13 of the secondary winding 6 is connected to a middle-point 14 of the plurality of output capacitors 12. For example, in the present example, the middle-point 14 is situated in the middle, particularly the middle of an electrical length, between the two output capacitors 12. In other embodiments, when more than two output capacitors 12 are provided, the middle-point 14 is defined as the middle between one half of total number of output capacitors 12 (for example, top two output capacitors 12 when providing in total four output capacitors 12) and another half of total number of output capacitors 12 (for example, the other bottom two output capacitors 12 when providing in total four output capacitors 12).

Generally, in converters 1, parasitic or stray capacitances are generated between the windings 4, 6 thereof as well as between the windings 4, 6 and a housing thereof. These parasitic capacitances lead to production of a common-mode voltage. At the star-point 13 of the secondary side 5 of the transformer device 2, this voltage oscillates and commonly demonstrates an oscillating frequency of roughly three times the operating frequency. Due to this common-mode voltage, especially with an oscillating frequency three times the frequency of operation, a resonance between resonance-inductance and the transformer parasitic inductance takes place. This resonance increases losses in the transformer device 2 and leads to higher temperatures, as well as lower efficiency of the converter 1.

However, in the present case, since the star-point 13 is connected to the middle-point 14 of the output capacitors 12, the common mode currents can be effectively diverted, and thereby oscillations of star point voltage is suppressed.

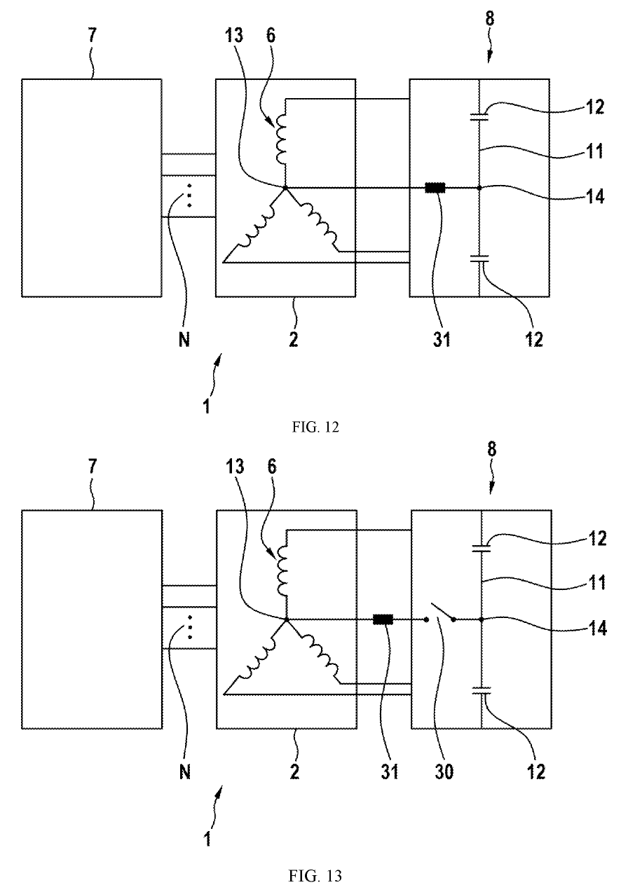

Furthermore, as demonstrated in FIG. 1, in an implementation, this connection between the star-point 13 and the middle-point 14 is achieved via a switch 30, which may be for example a relay or a transistor switch. In other implementations, this connection is achieved indirectly via an impedance 31, alternatively (FIG. 12) or in addition to the switch 30 (FIG. 13). In an implementation, apart from the switch 30 and/or the impedance 31, no further elements are connected between the star-point 13 and the middle-point 14. Thereby, the connection between the star-point 13 and the middle-point 14 can be selectively activated and de-activated depending on operational requirements and higher efficiency of the converter 1.

Now, with respect to FIGS. 2 – 11, embodiments will be described.

FIG. 2 shows a schematic diagram of a multi-phase converter 1 according to a second embodiment of the present application.

In FIG. 2, it is noted that the middle-point 14 is schematically shown as not in the middle between the output capacitors 12. This is, however, merely for ease of drawing. The star-point 13 of the secondary winding 6 is further connected to the middle-point 14 of the output capacitors 12.

Herein, the primary side circuit 7 comprises a plurality of primary switch legs 22 in parallel with one another, wherein each switch leg 22 comprises two switches 23 in series with one another. In general, the number of the primary switch legs 22 is not restricted to three, and especially corresponds to the number N of phases of the converter 1.

Furthermore, the primary side circuit 7 comprises an input capacitor leg 19 with an input capacitor 18. In an implementation, the primary side circuit 7, as also with the secondary side circuit 8, includes a plurality of input capacitors 18.

In the present embodiment, as shown in FIG. 2, the converter 1 is a unidirectional LLC resonant converter 1.

Herein, the primary side circuit 7 comprises delta connected resonant capacitors 21. Together with an inductance 27 on the primary side 3, these form a resonant tank for the LLC resonant converter 1.

The primary winding 4 of the present embodiment is connected in a delta configuration.

The secondary side circuit 8 further comprises a plurality of rectification legs 9 each with two rectification elements 10 and the output capacitor leg 11 with the output capacitors 12 mentioned above. In the present embodiment, all rectification elements 10 are diodes 10, wherein the diodes 10 are connected in series with one another.

As can be taken from FIG. 2, and as elucidated above, the star-point 13 of the secondary winding 6 is connected to the middle-point 14 of the plurality of output capacitors 12, thereby suppressing or reducing common mode voltages caused by parasitic capacitances in the transformer device 2.

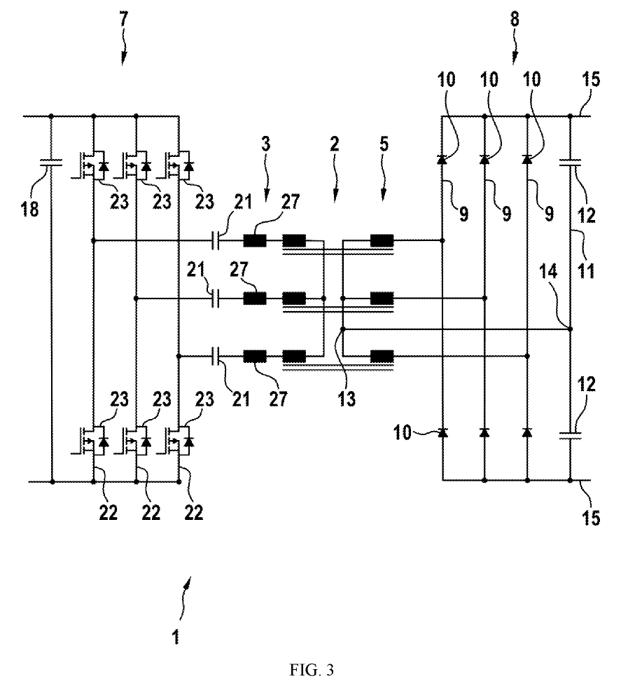

FIG. 3 shows a schematic diagram of a multi-phase converter 1 according to a third embodiment of the present application.

As can be taken from a comparison of FIG. 3 with FIG. 2, the converter 1 of the present embodiment is a unidirectional LLC resonant converter 1.

Herein, the primary winding 4, as also the secondary winding 6, is connected in a star configuration. The resonant inductors 27, i.e., the resonant tank, herein is also connected in star configuration.

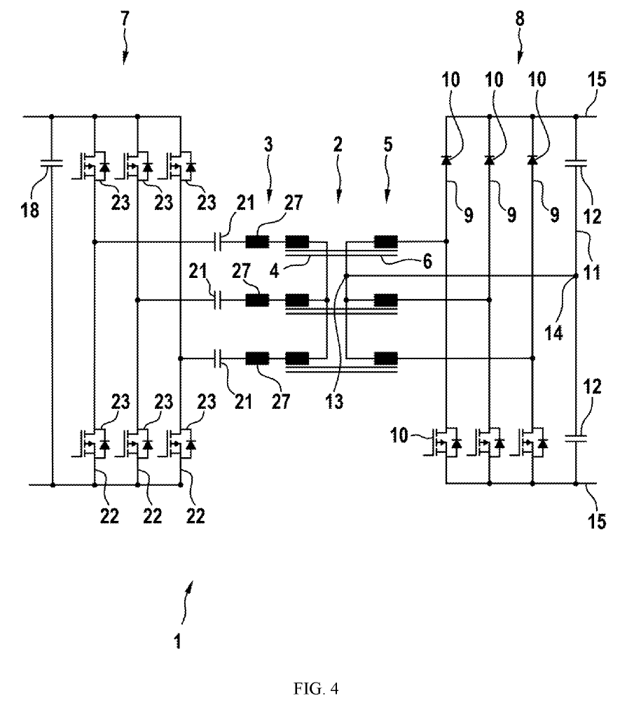

FIG. 4 shows a schematic diagram of a multi-phase converter 1 according to a fourth embodiment of the present application.

In the present embodiment, the converter 1 is a unidirectional series resonant converter 1, henceforth also referred to as SR converter 1.

Herein, the secondary side circuit 8 comprises, as rectification elements 10, diodes and switches.

Furthermore, although the middle-point 14 is shown at a different location as compared to the foregoing figures, this is merely for ease of drawing and understanding.

As shown in the present figure, the primary winding 4 and the secondary winding 6 are both connected in star configuration, with a star-point 13 of the secondary winding 6 being connected to the middle-point 14 of the output capacitors 12. The primary side circuit 7 comprises a plurality of resonant capacitors 21 connected to the plurality of primary switch legs 22 at one end and to the primary winding 4 in star configuration.

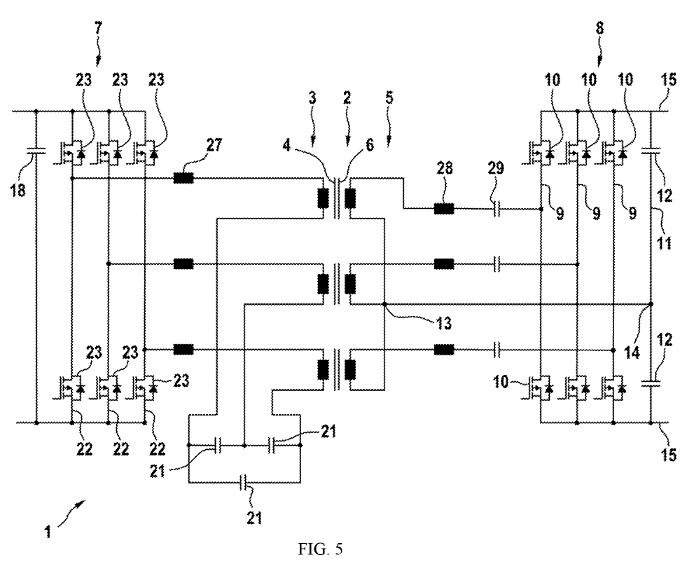

FIG. 5 shows a schematic diagram of a multi-phase converter 1 according to a fifth embodiment of the present application.

In the present embodiment, the converter 1 is a bidirectional LLC resonant converter 1. Herein, the secondary side circuit 8 comprises switches 10 as rectification elements 10.

Furthermore, an alternative circuit configuration of delta connected resonant capacitors 21 and primary winding 4 as well as of the secondary winding 6 is shown for easier understanding. In the present figure, the transformer device 2 is shown in up-down schematic circuit drawing, as compared with the horizontal circuit drawing of the previous figures, merely for easier understanding of the circuit.

Furthermore, in the present embodiment, the secondary side circuit 8 also comprises a resonant tank formed of a resonant inductance 28 and a resonant capacitor 29 (secondary side resonant inductance 28 and secondary side resonant capacitor 29). Along with the secondary winding 6, the corresponding secondary side resonant tank is star connected.

The primary side circuit 7 comprises delta connected primary side resonant capacitors 21.

Thereby, a bidirectional LLC converter 1 is achieved with suppressed or reduced common mode voltages and thereby lower losses and higher efficiency.

Herein, the three-phase transformer device 2 can be realized by means of three separate transformers or a three-limb or a five-limb integrated three-phase transformer. Further primary and/or secondary side resonant inductors can be integrated to respective three separate transformers or a three-limb or a five-limb integrated three-phase transformer.

Although in the present figure multiple transformer cores are schematically shown, it is also possible to provide one single core for an integrated transformer device 2.

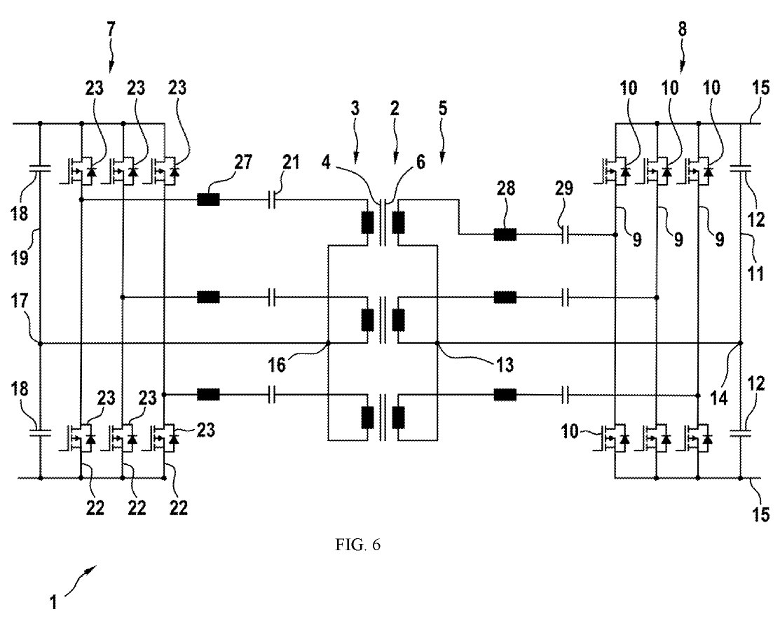

FIG. 6 shows a schematic diagram of a multi-phase converter 1 according to a sixth embodiment of the present application.

In the present embodiment, the bidirectional LLC resonant converter 1 further comprises a connection between a star-point 16 of the primary winding 4, which is star connection, and a middle-point 17 of the input capacitors 18 of the input capacitor leg 19 of the primary side circuit 7.

In the present embodiment, the primary winding 4 is connected in star configuration, and the primary side circuit 7 comprises a plurality of resonant capacitors 21 connected to the plurality of primary switch legs 22 at one end and to the primary winding 4 in star configuration.

In the present embodiment, the secondary side circuit 8 further comprises a resonant tank connected in star configuration along with the secondary winding 6. The primary side circuit 7 comprises a resonant tank connected along with the primary winding 4 in star configuration.

In the present embodiment, the converter 1 comprises the input capacitor leg 19, which presently further comprises two input capacitors 18. Herein, the middle-point 17 of the input capacitors 18 is defined, as above with respect to the middle-point 14 of the output capacitors 12, as the middle, especially the electrical middle, between the input capacitors 18. The plurality of primary switch legs 22 and the input capacitor leg 19 of the primary side circuit 7 and the rectification legs 9 and the output capacitor leg 11 of the secondary side circuit 8 are connected in star configuration.

Thereby, in bidirectional operation, especially when transferring power from the secondary side 5 to the primary side 3, common mode voltages can be reduced, i.e., common mode voltages and their corresponding resonances are reduced in both directions.

In an implementation, the connection between the primary side star-point 16 and the middle-point 17 of the input capacitors 18 comprises a switch (not shown) or impedance, as described with reference to FIG. 1. Thereby, it is possible to activate the connection in reverse power mode (secondary to primary power transfer), and to de-activate the connection in forward power mode (primary to secondary power transfer). Thus, it is possible to increase efficiency by de-activating the connection in forward power mode, while also providing capability of reducing or suppressing common mode voltages in the reverse power mode.

Accordingly, in an implementation, the connection between the secondary side star-point 13 and the middle-point 14 of the output capacitors 12 in addition or alternatively to the above comprises the switch 30 or impedance of FIGS. 1, 12 or 13. Thereby, when transferring power in reverse mode, the connection can be de-activated.

In other words, in an implementation, in forward power mode, the connection of the secondary side star-point 13 is activated and that of the primary side star-point 16 is de-activated, while in reverse power mode the connection of the secondary side star-point 13 is de-activate and that of the primary side star-point 16 is activated.

Thereby, high efficiency in both power transfer directions of the bidirectional converter 1 are achieved.

In an implementation, the aforementioned connections of primary side star-point 16 and secondary side star-point 13 apply to all of the foregoing and following embodiments, where a star connection of corresponding windings 4, 6 are present. In particular, in any of the foregoing and following embodiments in which the primary winding 4 is in star connection, in an implementation, the primary side star-point 16 is connected to the middle-point 17 of the input capacitors 18.

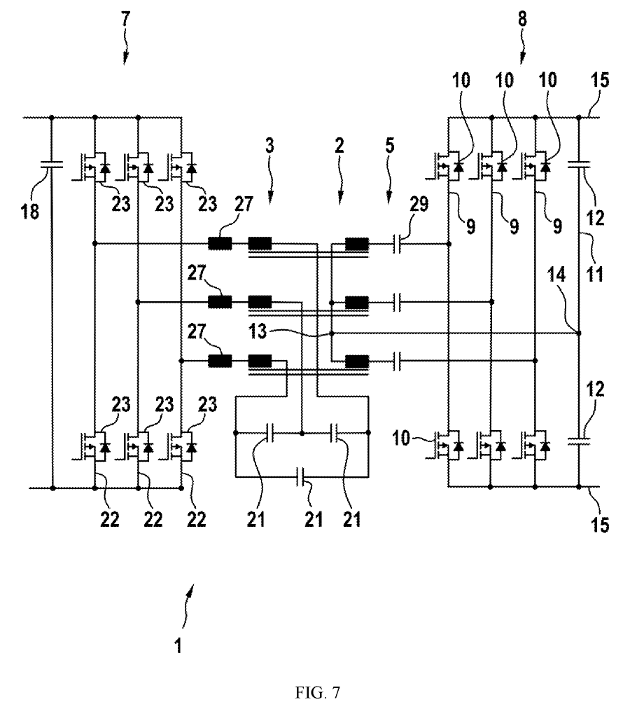

FIG. 7 shows a schematic diagram of a multi-phase converter 1 according to a seventh embodiment of the present application.

Similar to FIG. 4, the converter 1 of the present embodiment is a series resonant converter 1. Herein, the converter 1 is bidirectional. As can be taken from FIG. 7, the rectification elements 10 of the secondary side circuit 8 are switches.

Additionally, the primary side circuit 7 comprises a delta connected resonant tank, i.e., delta connected resonant capacitors 21 and resonant inductances 27. The primary winding 4 and the secondary winding 6 are connected in star configuration.

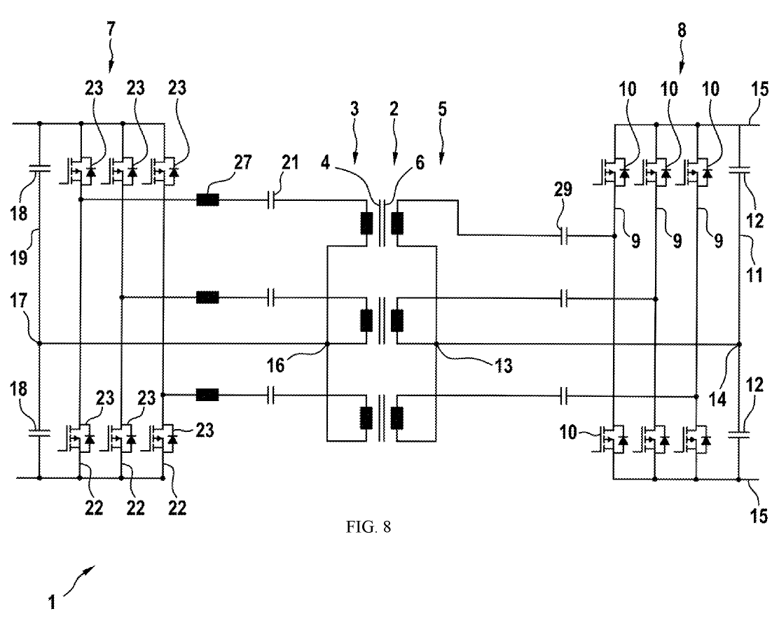

FIG. 8 shows a schematic diagram of a multi-phase converter 1 according to an eighth embodiment of the present application.

In the present embodiment, the converter 1 is a bidirectional series resonant converter 1, as in FIG. 7. Herein, the converter 1 further comprises an input capacitor leg 19 with a plurality of input capacitors 18 connected in series, the primary side star-point 16 is connected to the middle-point 17 of the input capacitors 18, as also elucidated above. The plurality of primary switch legs 22 and the input capacitor leg 19 of the primary side circuit 7 and the rectification legs 9 and the output capacitor leg 11 of the secondary side circuit 8 are connected in star configuration.

In the present embodiment, the primary winding 4 is connected in star configuration, and the primary side circuit 7 comprises a plurality of resonant capacitors 21 connected to the plurality of primary switch legs 22 at one end and to the primary winding 4 in star configuration.

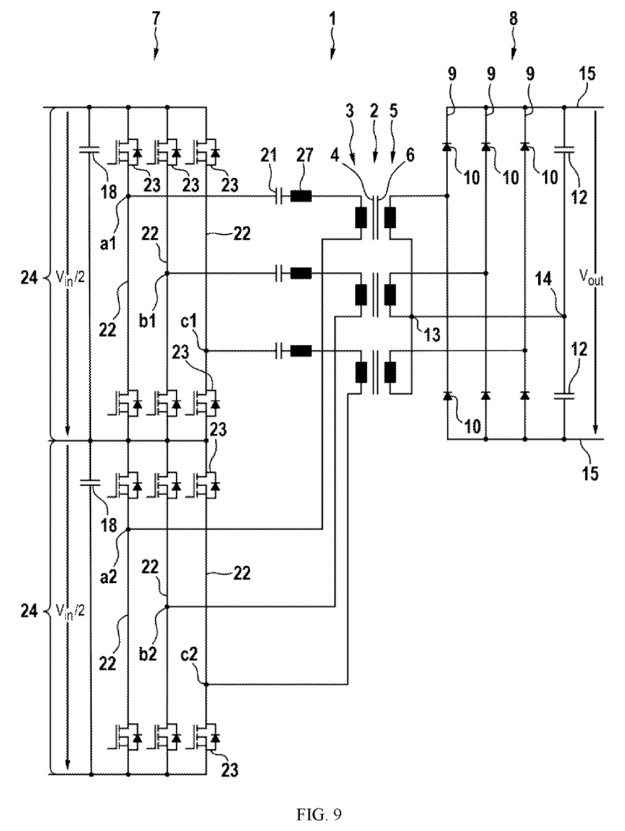

In the present embodiment, the secondary side circuit 8 further comprises a resonant tank connected in star configuration along with the secondary winding 6. The primary side circuit 7 comprises a resonant tank connected along with the primary winding 4 in star configuration. FIG. 9 shows a schematic diagram of a multi-phase converter 1 according to a ninth embodiment of the present application.

In the present embodiment, the primary side circuit 7 comprises a plurality of primary switch legs 22, each with primary switches 23 in series with one another. Furthermore, each of the primary switch legs 22 comprises a plurality of stacked primary half-bridges 24 connected in series with one another.

Herein, each of the stacked primary half-bridges 24 receives half the input voltage (Vin/2). The primary winding 4 of each phase of the transformer device 2 is connected between a first switch leg 22 of a top stacked primary half-bridge 24 and a second switch leg 22, in series with the first switch leg 22, of a bottom stacked primary half-bridge 24. In other words, one phase of the primary side 3 of the transformer device 2 is connected between two different stacked primary half-bridges 24 in series with one another. In FIG. 9, respective connection points a1, a2 for a first phase, b1, b2 for a second phase, and c2, c2 for a third phase are shown.

In the present embodiment, the primary side circuit 7 further comprises an input capacitor leg 19 with a plurality of input capacitors 18, the plurality of input capacitors 18 are connected in parallel with the stacked primary half-bridges 24 respectively.

As can be taken from FIG. 9, the converter 1 is unidirectional.

Thereby, a multi-phase and multi-level LLC resonant converter 1 is achieved with reduced or suppressed common mode currents.

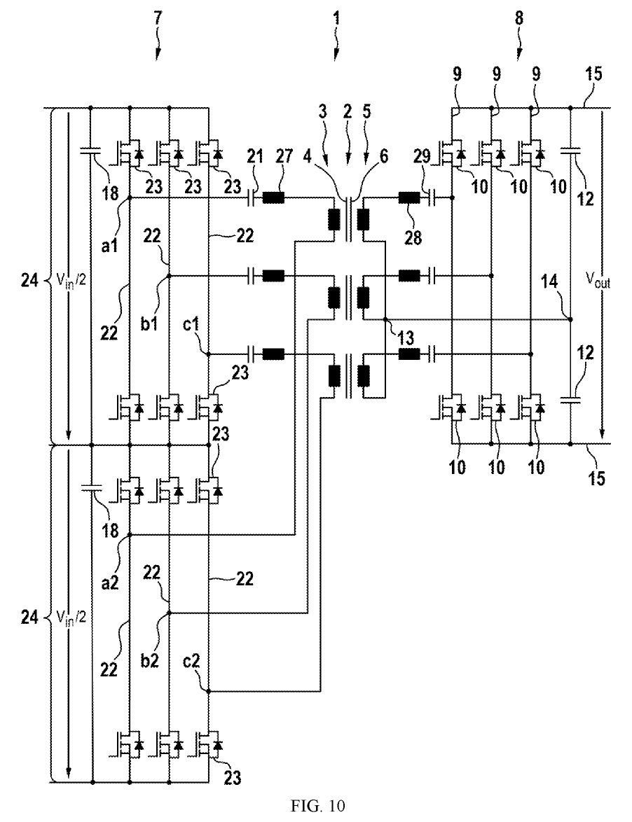

FIG. 10 shows a schematic diagram of a multi-phase converter 1 according to a tenth embodiment of the present application.

In the present embodiment, the multi-phase and multi-level LLC resonant converter 1 as a bidirectional converter 1 is shown. Therein, the secondary side circuit 8 comprises switches 10 as rectification elements.

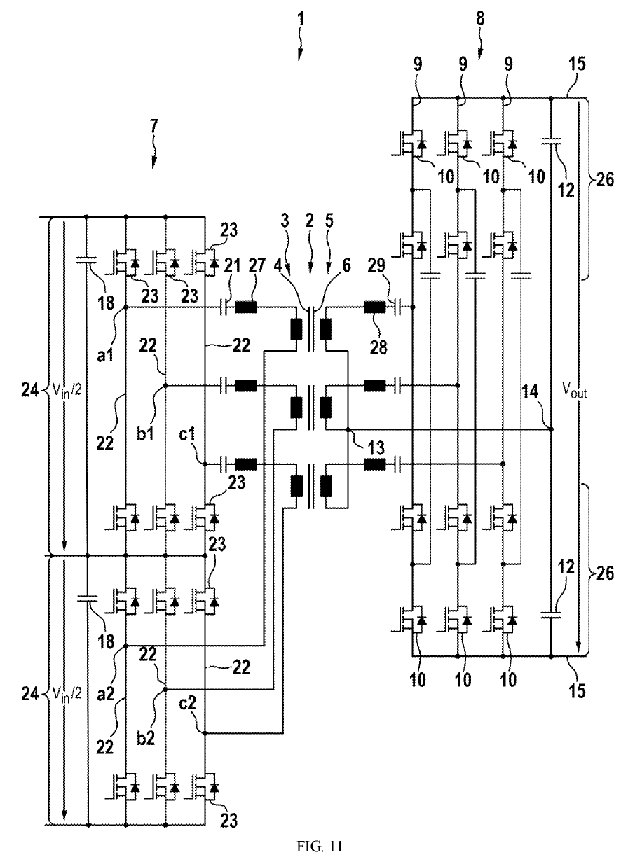

FIG. 11 shows a schematic diagram of a multi-phase converter 1 according to an eleventh embodiment of the present application.

In the present embodiment, in comparison with the embodiment of FIG. 10, each of the secondary rectifier legs 9 comprises a plurality of stacked secondary half-bridges 26 connected in series with one another, the rectification legs 9 are connected in parallel to one another; and one phase of the secondary side 5 of the transformer device 2 is connected between two stacked secondary half-bridges 26 in series with one another.

In the present embodiment, for each of the rectification legs 9, a flying capacitor is connected between the stacked secondary half-bridges 26 connected in series.

Thereby, a multi-phase and multi-level LLC resonant converter 1 with high efficiency in both power transfer directions is achieved.

FIG. 12 shows a schematic diagram of a multi-phase converter 1 according to a twelfth embodiment of the present application.

In FIG. 12, the above explanation with regard to the switch 30 of FIG. 1 alternatively being an impedance 31 is shown.

FIG. 13 shows a schematic diagram of a multi-phase converter 1 according to a thirteenth embodiment of the present application.

In FIG. 13, a combination of the switch 30 and the impedance 31 is shown.

The two foregoing described embodiments twelve and thirteen provide further efficiency via switchability of the star-point 13 connection to the middle-point 14. Thereby, especially in combination with bidirectional embodiments, this connection can be selectively activated and de-activated for higher efficiency, especially depending on operation direction. Furthermore, it is to be understood that the switch 30 and/or impedance 31 of the foregoing embodiments twelve and thirteen may in addition or alternatively also apply to the connection of the primary side star-point 16 to the primary side middle-point 17.

By the foregoing described embodiments, a multi-phase converter 1 is achieved in which common-mode voltages are suppressed, and which further comprises reduced or no resonance between resonance-inductance and transformer parasitic inductance, and which has lower losses, lower temperature, and higher efficiency. The foregoing described embodiments are combinable.

In addition to the foregoing written explanations, it is explicitly referred to FIGS. 1 to 13, wherein the figures in detail show circuit diagrams and configuration examples of the application. Details on components, especially electrical and/or magnetic components, as well as their interconnections can be explicitly taken therefrom.

What is claimed is:

1. A multi-phase converter, comprising:
a transformer device with a primary side with primary winding and a secondary side with secondary winding;
a primary side circuit connected to the primary winding and comprising a plurality of primary switch legs in parallel; and
a secondary side circuit connected to the secondary winding; wherein
the secondary side circuit comprises a plurality of rectification legs with rectification elements and an output capacitor leg with a plurality of output capacitors,
the secondary winding is connected in star configuration, and
a star-point of the secondary winding is connected to a middle-point of the plurality of output capacitors.

2. The multi-phase converter according to claim 1, wherein the output capacitor leg is directly connected, in parallel, between the rectification legs and an output of the secondary side circuit.

3. The multi-phase converter according to claim 1, wherein the output capacitor leg comprises a plurality of output capacitors connected in series with one another, and wherein the middle-point is substantially in the middle of all output capacitors, wherein the middle of all output capacitors refers to the electrical middle of all output capacitors.

4. The multi-phase converter according to claim 3, wherein the output capacitor leg comprises an even number of output capacitors connected in series with one another.

5. The multi-phase converter according to claim 1, wherein the star-point of the secondary winding is connected to the middle-point of the output capacitors directly or via an impedance and/or via a switch.

6. The multi-phase converter according to claim 1, wherein the primary winding is connected in delta configuration and the primary side circuit comprises a plurality of resonant capacitors connected to the primary winding in delta configuration.

7. The multi-phase converter according to claim 6, wherein the multi-phase converter is bidirectional, and the secondary side circuit further comprises a resonant tank connected in star configuration along with the secondary winding.

8. The multi-phase converter according to claim 1, wherein the primary winding is connected in star configuration, and the primary side circuit comprises a plurality of resonant capacitors connected to the plurality of primary switch legs at one end and to the primary winding in star configuration.

9. The multi-phase converter according to claim 8, wherein the multi-phase converter is bidirectional, and the secondary side circuit further comprises a resonant tank connected in star configuration along with the secondary winding.

10. The multi-phase converter according to claim 9, wherein the multi-phase converter further comprises an input capacitor leg with a plurality of input capacitors connected in series, and a middle-point of the input capacitor leg is connected to a star-point of the primary winding.

11. The multi-phase converter according to claim 8, wherein the primary side circuit comprises a resonant tank connected to the primary winding in delta configuration.

12. The multi-phase converter according to claim 8, wherein the primary side circuit comprises a resonant tank connected along with the primary winding in star configuration.

13. The multi-phase converter according to claim 1, wherein each of the primary switch legs comprises a plurality of stacked primary half-bridges connected in series with one another, the primary switch legs are connected in parallel to one another; and wherein one phase of the primary side of the transformer device is connected between two stacked primary half-bridges in series with one another.

14. The multi-phase converter according to claim 13, wherein the primary side circuit further comprises an input capacitor leg with a plurality of input capacitors, the plurality of input capacitors are connected in parallel with the stacked primary half-bridges respectively.

15. The multi-phase converter according to claim 13, wherein each of the rectification legs of the secondary side circuit comprises a plurality of stacked secondary half-bridges connected in series with one another, the rectification legs are connected in parallel to one another; and wherein one phase of the secondary side of the transformer device is connected between two stacked secondary half-bridges in series with one another.

16. The multi-phase converter according to claim 15, wherein for each of the rectification legs, a flying capacitor is connected between the stacked secondary half-bridges connected in series.

17. The multi-phase converter according to claim 13, wherein the multi-phase converter is a multi-phase multi-level converter.

18. The multi-phase converter according to claim 1, wherein the multi-phase converter is an LLC converter and the rectification elements of the rectification legs are diode.

19. The multi-phase converter according to claim 1, wherein the multi-phase converter is a series resonant converter and the rectification elements of the rectification legs comprise diodes and switches.

20. The multi-phase converter according to claim 1, wherein the multi-phase converter is bidirectional, and the primary side circuit comprises an input capacitor leg, the plurality of primary switch legs and the input capacitor leg of the primary side circuit and the rectification legs and the output capacitor leg of the secondary side circuit are connected in star configuration.
